(19) United States
(12) Patent Application Publication
(10) Pub. No.: US 2019/0066580 A1
(43) Pub. Date: Feb. 28, 2019

(54) PIXEL CIRCUIT, DRIVING METHOD THEREOF, AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventor: Yingsong XU, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu (CN)

(21) Appl. No.: 15/957,547

(22) Filed: Apr. 19, 2018

(30) Foreign Application Priority Data
Aug. 29, 2017 (CN) 201710762505.5

(51) Int. Cl. G09G 3/3233

(52) U.S. Cl. CPC G09G 3/3233; G09G 2300/0819; G09G 2320/0233; G09G 2320/045

(57) ABSTRACT

The present disclosure provides a pixel circuit, a driving method thereof, and a display device. The pixel circuit includes: a resetting module configured to output a voltage from an initial voltage end to a driving module and a light-emitting module; a data write-in module configured to write a voltage from a data voltage end to the driving module; a compensation module configured to compensate a threshold voltage of the driving module and output a voltage from a first voltage end to the driving module; the light-emitting module configured to emit light in accordance with a driving current from the driving module; and the driving module configured to drive the light-emitting module to emit light. The pixel circuit is used to drive subpixels to display an image.

### CROSS-REFERENCE TO RELATED APPLICATION

This application claims priority to Chinese Patent Application No. 201710762505.5 filed on Aug. 29, 2017, which is incorporated herein by reference in its entirety.

### TECHNICAL FIELD

The present disclosure relates to the field of display technology, in particular to a pixel circuit, a driving method thereof, and a display device.

### BACKGROUND

As a current-mode light-emitting element, an organic light-emitting diode (OLED) has been widely used in the field of high-performance display due to such advantages as self-luminescence, rapid response, wide viewing angle and being capable of being formed on a flexible substrate.

Depending on its driving mode, the OLED may include passive matrix driving OLED (PMOLED) and active matrix driving OLED (AMOLED). An AMOLED display device is expected to replace a liquid crystal display (LCD) and become a next-generation planar display device due to its advantages such as low manufacture cost, rapid response, being power-saving, being capable of being driven by a direct current for a portable device, and a large operating temperature range.

For a conventional AMOLED display panel, each subpixel is provided with a pixel circuit which includes a plurality of thin film transistors (TFTs). Currents flowing through the OLEDs of the AMOLED display panel may differ from each other to some extent due to a drift of a threshold voltage Vth of each TFT. Hence, brightness evenness and brightness stability of the display device may be adversely affected, and thereby image quality of the display device may be degraded.

### SUMMARY

In one aspect, the present disclosure provides in some embodiments a pixel circuit, including a resetting module, a data write-in module, a compensation module, a driving module, and a light-emitting module. The resetting module is connected to a resetting signal end, a scanning signal end, an initial voltage end, the driving module and the light-emitting module, and configured to output a voltage from the initial voltage end to the driving module and the light-emitting module under the control of the resetting signal end and the scanning signal end. The data write-in module is connected to a data voltage end, an enabling signal end and the driving module, and configured to write a voltage from the data voltage end into the driving module under the control of the enabling signal end. The compensation module is connected to a first signal end, a second signal end, a first voltage end and the driving module, and configured to compensate a threshold voltage of the driving module under the control of the first signal end and the second signal end, and output a voltage from the first voltage end to the driving module. The light-emitting module is connected to the first signal end, a second voltage end and the driving module, and configured to emit light in accordance with a driving current from the driving module under the control of the first signal end. The first voltage end is configured to output a constant high level, and the second voltage end is configured to output a constant low level.

In a possible embodiment of the present disclosure, the resetting module includes: a first transistor, a gate electrode of which is connected to the resetting signal end, a first electrode of which is connected to the driving module, and a second electrode of which is connected to the initial voltage end; and a second transistor, a gate electrode of which is connected to the scanning signal end, a first electrode of which is connected to the driving module and the light-emitting module, and a second electrode of which is connected to the first electrode of the first transistor.

In a possible embodiment of the present disclosure, the data write-in module includes a third transistor, a gate electrode of which is connected to the enabling signal end, a first electrode of which is connected to the data voltage end, and a second electrode of which is connected to the driving module.

In a possible embodiment of the present disclosure, the compensation module includes: a fourth transistor, a gate electrode of which is connected to the second signal end, a first electrode of which is connected to the first voltage end, and a second electrode of which is connected to the driving module; and a fifth transistor, a gate electrode of which is connected to the first signal end, a first electrode of which is connected to the second electrode of the fourth transistor, and a second electrode of which is connected to the driving module.

In a possible embodiment of the present disclosure, the driving module includes a driving transistor and a storage capacitor. A gate electrode of the driving transistor is connected to one end of the storage capacitor, a first electrode of the driving transistor is connected to the compensation module, a second electrode of the driving transistor is connected to the light-emitting module, and another end of the storage capacitor is connected to the compensation module.

In a possible embodiment of the present disclosure, the light-emitting module includes a sixth transistor and a light-emitting element. A gate electrode of the sixth transistor is connected to the first signal end, a first electrode of the sixth transistor is connected to the driving module, a second electrode of the sixth transistor is connected to an anode of the light-emitting element, and a cathode of the light-emitting element is connected to the second voltage end.

In a possible embodiment of the present disclosure, the light-emitting element is a light-emitting diode (LED) or an OLED.

In another aspect, the present disclosure provides in some embodiments a display device including the above-mentioned pixel circuit.

In a possible embodiment of the present disclosure, the display device further includes a display panel on which a plurality of subpixels is arranged in a matrix form. The pixel circuit is arranged in each subpixel. The subpixels in each row are connected to a control signal line, an enabling signal line and a scanning signal line. A first signal end of the pixel circuit is connected to the control signal line, and an enabling signal end is connected to the enabling signal line. Apart from the subpixels in a first row, a second signal end of the pixel circuit in each subpixel in a current row is connected to the control signal line which is connected to the subpixels in a previous row, and a resetting signal end of the pixel circuit in each subpixel in the current row is connected to the enabling signal line which is connected to the subpixels in the previous row.

In a possible embodiment of the present disclosure, the display device further includes a voltage-mode source driver connected to a data voltage end of each pixel circuit and configured to apply a data voltage to the data voltage end.

In yet another aspect, the present disclosure provides in some embodiments a method for driving the above-mentioned pixel circuit, including steps of: at a resetting stage within each frame, outputting, by a resetting module, a voltage from an initial voltage end to a driving module and a light-emitting module under the control of a resetting signal end and a scanning signal end; at a write-in compensation stage within each frame, writing, by a data write-in module, a voltage from a data voltage end into the driving module under the control of an enabling signal end, and compensating, by a compensation module, a threshold voltage of the driving module under the control of a first signal end and a second signal end; and at a light-emission stage within each frame, outputting, by the compensation module, a voltage from a first voltage end to the driving module under the control of the first signal end and the second signal end, and emitting, by the light-emitting module, light in accordance with a driving current from the driving module under the control of the first signal end.

In a possible embodiment of the present disclosure, the compensation module includes a fourth transistor, and the driving module includes a driving module and a storage capacitor. At the write-in compensation stage, the method further includes: charging, by the storage capacitor, a gate electrode of the driving transistor; enabling the fourth transistor to be turned on under the control of the second signal end to enable the voltage from the first voltage end to be applied to a first electrode of the driving transistor via the fourth transistor; and enabling a threshold voltage of the driving transistor and the voltage from the first voltage end to be written into the gate electrode of the driving transistor.

In a possible embodiment of the present disclosure, at the resetting stage, each of the resetting signal end, the scanning signal end and the first signal end outputs a low level. At the write-in compensation stage, each of the enabling signal end, the second signal end and the scanning signal end outputs a low level, and the data voltage end outputs a data voltage. At the light-emission stage, each of the first signal end and the second signal end outputs a low level.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic view showing a pixel circuit;

FIG. 2 is a schematic view showing a pixel circuit according to one embodiment of the present disclosure;

FIG. 3 is a circuit diagram of the pixel circuit in FIG. 2;

FIG. 4 is a sequence diagram of driving signals for the pixel circuit in FIG. 3;

FIG. 5 is a schematic view showing on and off states of transistors of the pixel circuit in FIG. 4 at a resetting stage;

FIG. 6 is another sequence diagram of the driving signals for the pixel circuit in FIG. 3;

FIG. 7 is a schematic view showing the on and off states of the transistors of the pixel circuit in FIG. 6 at a write-in compensation stage;

FIG. 8 is yet another sequence diagram of the driving signals for the pixel circuit in FIG. 3;

FIG. 9 is a schematic view showing the on and off states of the transistors of the pixel circuit in FIG. 8 at a light-emission stage; and

FIG. 10 is a topical schematic view of a display panel of a display device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

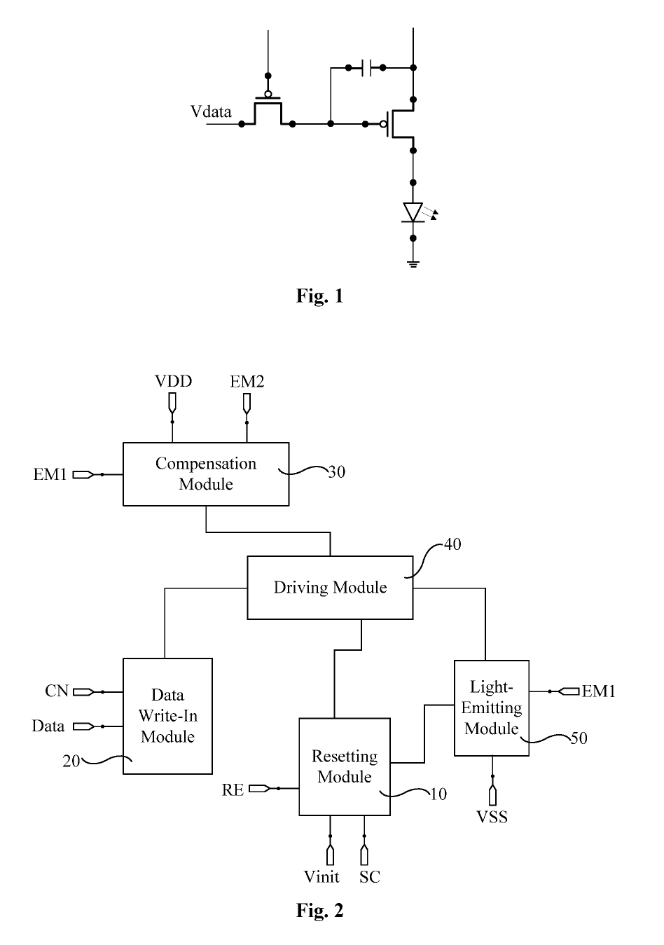

In the related art, as shown in FIG. 1, a pixel circuit is of a 2T1C structure, i.e., it includes two transistors and one capacitor. However, due to the limitation of a manufacture process and features of poly-silicon, in the case that an Excimer Laser Annealing (ELA) or doping process is adopted for manufacturing TFTs on a large-size glass substrate, it is impossible to ensure the uniform performance of all the TFTs, and the drift of a threshold voltage may occur for some TFTs. In this way, a current flowing through OLEDs of an AMOLED display panel may change along with the drift of the threshold voltage Vth of the TFT. Hence, brightness evenness and brightness stability of the display device may be adversely affected, and thereby image quality of the display device may be degraded.

The present disclosure provides in some embodiments a pixel circuit which, as shown in FIG. 2, includes a resetting module 10, a data write-in module 20, a compensation module 30, a driving module 40, and a light-emitting module 50.

The resetting module 10 is connected to a resetting signal end RE, a scanning signal end SC, an initial voltage end Vinit, the driving module 40 and the light-emitting module 50, and configured to output a voltage from the initial voltage end Vinit to the driving module 40 and the light-emitting module 50 under the control of the resetting signal end RE and the scanning signal end SC. In this way, it is able to reset the driving module 40 and the light-emitting module 50 through a signal from the initial voltage end Vinit to prevent an image to be displayed within a current frame from being adversely affected by a residual voltage applied to the driving module 40 and the light-emitting module 50 within a previous frame.

The data write-in module 20 is connected to a data voltage end Data, an enabling signal end CN and the driving module 40, and configured to write a voltage from the data voltage end Data into the driving module 40 under the control of the enabling signal end CN. In this way, it is able for the driving module 40 to output a driving current to the light-emitting module 50 in accordance with a data voltage Vdata, thereby to drive the light-emitting module 50 to emit light.

The compensation module 30 is connected to a first signal end EM1, a second signal end EM2, a first voltage end VDD and the driving module 40, and configured to compensate a threshold voltage Vth of the driving module 40 under the control of the first signal end EM1 and the second signal end EM2, and output a voltage from the first voltage end VDD to the driving module 40.

The light-emitting module 50 is connected to the first signal end EM1, a second voltage end VSS and the driving module 40, and configured to emit the light in accordance with the driving current from the driving module 40 under the control of the first signal end EM1.

In the embodiments of the present disclosure, the first voltage end VDD is configured to output a constant high level, and the second voltage end VSS is configured to output a constant low level (e.g., the second voltage end VSS may be grounded). Here, the words “high” and “low” are merely used to represent a size of one voltage relative to another.

According to the pixel circuit in the embodiments of the present disclosure, before the light-emitting module 50 emits the light, the driving module 40 and the light-emitting module 50 may be reset through the resetting module 10 to prevent the image to be displayed within the current frame from being adversely affected by the residual voltage applied to the driving module 40 and the light-emitting module 50 within the previous frame. In addition, the data voltage Vdata from the data voltage end Data may be written into the driving module through the data write-in module, so the driving module 40 may generate the driving current in accordance with the data voltage so as to drive the light-emitting module 50 to emit the light. Further, the compensation module 30 may compensate the threshold voltage Vth of the driving module 40, and in this case, the driving current generated by the driving module 40 is independent of the threshold voltage Vth of a driving transistor of the driving module 40. As a result, in the case that each subpixel of a display panel is provided with the above-mentioned pixel circuit, the driving current flowing through the light-emitting module 50 of the pixel circuit in each subpixel may be independent of the threshold voltage Vth of the driving transistor of the pixel circuit, so it is able to prevent the occurrence of non-uniform driving current due to the different threshold voltages of the driving transistors of the subpixels, thereby to prevent the occurrence of non-uniform brightness.

The structures of the modules in FIG. 2 will be described hereinafter in more details.

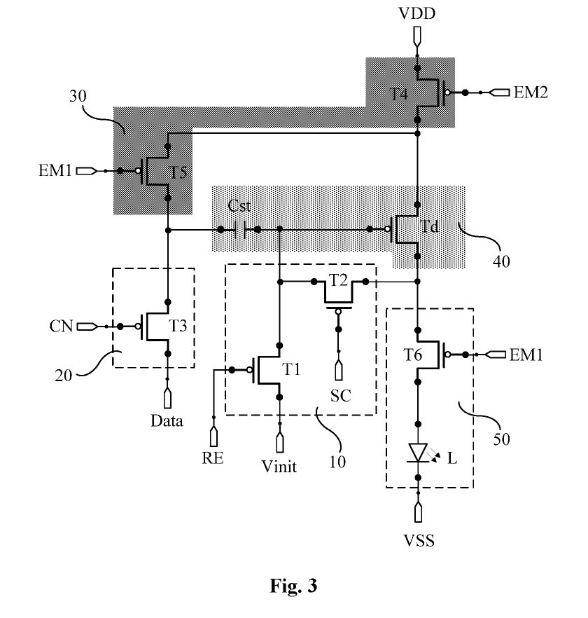

To be specific, as shown in FIG. 3, the driving module 40 includes a driving transistor Td and a storage capacitor Cst. A gate electrode of the driving transistor Td is connected to one end of the storage capacitor Cst, a first electrode thereof is connected to the compensation module 30, and a second electrode thereof is connected to the light-emitting module 50. The other end of the storage capacitor Cst is connected to the compensation module 30.

The resetting module 10 includes a first transistor T1 and a second transistor T2. A gate electrode of the first transistor T1 is connected to the resetting signal end RE, a first electrode thereof is connected to the driving module 40, and a second electrode thereof is connected to the initial voltage end Vinit. In the case that the driving transistor 40 has the above-mentioned structure, the first electrode of the first transistor T1 is connected to the gate electrode of the driving transistor Td. In this way, in the case that the first transistor T1 is turned on under the control of the resetting signal end RE, a voltage applied to the initial voltage end Vinit may be applied to the gate electrode of the driving transistor Td via the first transistor T1 to reset the gate electrode of the driving transistor Td and prevent the image to be displayed within the current frame from being adversely affected by the residual voltage applied to the gate electrode of the driving transistor Td within the previous frame. A gate electrode of the second transistor T2 is connected to the scanning signal end SC, a first electrode thereof is connected to the driving module 40 and the light-emitting module 50, and a second electrode thereof is connected to the first electrode of the first transistor T1.

The light-emitting module 50 includes a sixth transistor T6 and a light-emitting element L. A gate electrode of the sixth transistor T6 is connected to the first signal end EM1, a first electrode thereof is connected to the driving module 40, and a second electrode thereof is connected to an anode of the light-emitting element L. A cathode of the light-emitting element L is connected to the second voltage end VSS. The light-emitting element L may be an LED or an OLED.

In the case that the driving module 40 has the above-mentioned structure, the first electrode of the second transistor T2 of the resetting module 10 is connected to the second electrode of the driving transistor Td. In addition, the first electrode of the sixth transistor T6 of the light-emitting module 50 is connected to the second electrode of the driving transistor Td. In this way, in the case that the sixth transistor T6, the second transistor T2 and the first transistor T1 are all turned on, the voltage applied to the initial voltage end Vinit may be applied to the anode of the light-emitting element L via these transistors which have been turned on to reset the light-emitting element L, thereby to prevent the image to be displayed within the current frame from being adversely affected by the residual voltage applied to the anode of the light-emitting element L within the previous frame.

The data write-in module 20 includes a third transistor T3, a gate electrode of which is connected to the enabling signal end CN, a first electrode of which is connected to the data voltage end Data, and a second electrode of which is connected to the driving module 40. In the case that the driving module 40 has the above-mentioned structure, the second electrode of the third transistor T3 is connected to the other end of the storage capacitor Cst. In the case that the third transistor T3 is turned on, the data voltage Vdata applied to the data voltage end Data may be stored in the storage capacitor Cst, and then continuously applied to the gate electrode of the driving transistor Td.

The compensation module 30 includes a fourth transistor T4 and a fifth transistor T5. A gate electrode of the fourth transistor T4 is connected to the second signal end EM2, a first electrode thereof is connected to the first voltage end VDD, and a second electrode thereof is connected to the driving module 40. In the case that the driving module 40 has the above-mentioned structure, the second electrode of the fourth transistor T4 is connected to the first electrode of the driving transistor Td. A gate electrode of the fifth transistor T5 is connected to the first signal end EM1, a first electrode thereof is connected to the second electrode of the fourth transistor T4, and a second electrode thereof is connected to the driving module 40. In the case that the driving module 40 has the above-mentioned structure, the second electrode of the fifth transistor is connected to the other end of the storage capacitor Cst.

It should be appreciated that, the types of the transistors in the embodiments of the present disclosure will not be particularly defined herein. For example, the transistors may be N-type transistors, and in this case, the first electrode of each transistor is a drain electrode while a second electrode thereof is a source electrode. Of course, the transistors may also be P-type transistors, and in this case, the first electrode of each transistor is a source electrode while a second electrode thereof is a drain electrode. In addition, each transistor may be an enhanced or depleted transistor.

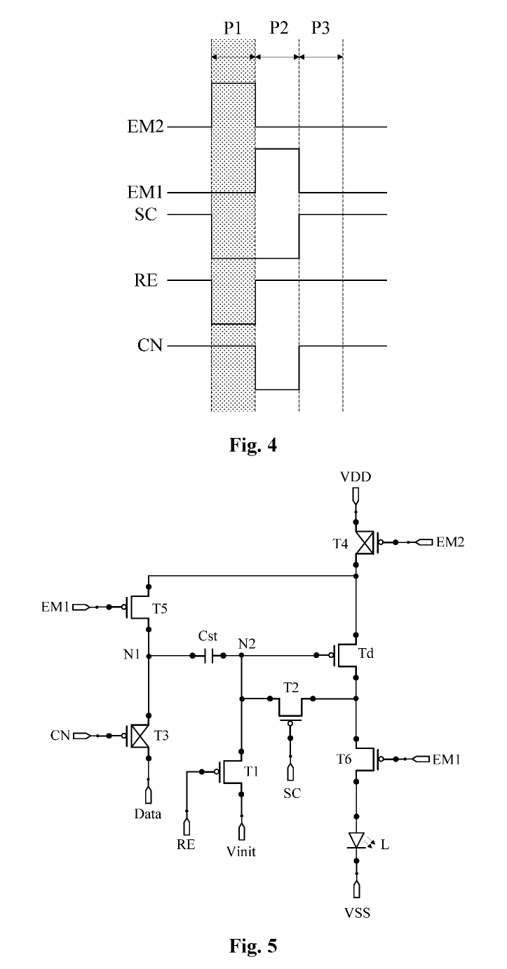

The operation of the pixel circuit in FIG. 3 within each frame will be described hereinafter in more details in conjunction with the signal sequences in FIGS. 4, 6 and 8, by taking the P-type, enhanced TFTs as an example. Each frame includes a resetting stage P1, a write-in compensation stage P2 and a light-emission stage P3.

To be specific, at the resetting stage P1 within each frame, as shown in FIG. 4, EM2=1, EM1=0, SC=0, RE=0 and CN=1. In the embodiments of the present disclosure, “0” represents a low level and “1” represents a high level.

In this case, as shown in FIG. 5, a low level is applied to the resetting signal end RE, so the first transistor T1 is turned on. A low level is applied to the scanning signal end SC, so the second transistor T2 is turned on. A low level is applied to the first signal end EM1, so the fifth transistor T5 and the sixth transistor T6 are turned on.

At this time, the voltage applied to the first voltage end Vinit is applied to the gate electrode of the driving transistor Td via the first transistor T1. For the voltage Vg applied to the gate electrode of the driving transistor Td, Vg=V_{N2}=Vinit, i.e., the voltage applied to the gate electrode of the driving transistor Td may be reset as the voltage applied to the initial voltage end Vinit.

Because the fifth transistor T5 is turned on, a voltage applied to a node N1 is identical to a voltage Vs applied to the source electrode of the driving transistor Td. Based on the above, the node N1 is reset through the initial voltage end Vinit, until V_{N1}=Vs=Vinit−Vth (V_{N1} represents the voltage applied to the node N1). In the case that Vs=Vinit−Vth, Vgs=Vg−Vs=Vinit− (Vinit−Vth)=Vth (Vgs represents a gate-to-source voltage of the driving transistor Td). At this time, the driving transistor Td is in a critical, cut-off state. For the enhanced, P-type transistor, a cut-off condition is Vgs>Vth, where Vth is a negative value.

Based on the above, the voltage applied to the initial voltage end Vinit may be applied to the anode of the light-emitting element L via the first transistor T1, the second transistor T2 and the sixth transistor T6 to reset the anode of the light-emitting element L as the voltage applied to the initial voltage end Vinit. In addition, the third transistor T3 and the fourth transistor T4 are in the cut-off state.

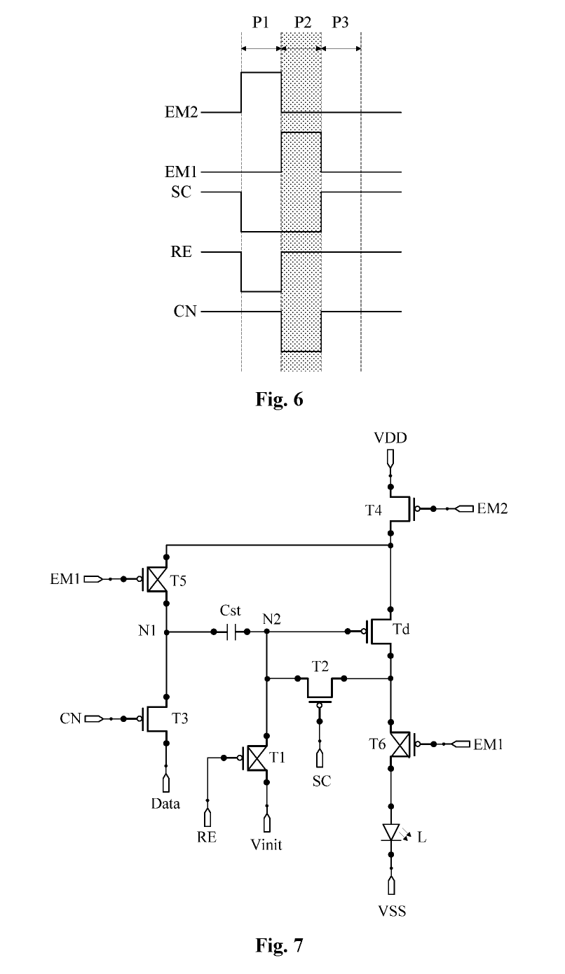

At the write-in compensation stage P2 within each frame, as shown in FIG. 6, EM2=0, EM1=1, SC=0, RE=1 and CN=0.

In this case, a low level is applied to the enabling signal end CN, so the third transistor T3 is turned on and the data voltage Vdata applied to the data voltage end Data is applied to the node N1 via the third transistor T3, as shown in FIG. 7. At this time, V_{N1}=Vdata.

A low level is applied to the scanning signal end SC, so the second transistor T2 is turned on. A low level is applied to the second signal end EM2, so the fourth transistor T4 is turned on. As mentioned above, the voltage applied to the initial voltage end Vinit is applied to the gate electrode of the driving transistor Td, i.e., the voltage applied to the gate electrode of the driving transistor Td is of a low level. At this time, the driving transistor Td is turned on, and Vgs<Vth. Because the second transistor T2 is turned on, the voltage Vg applied to the gate electrode of the driving transistor Td is identical to a voltage applied to the drain electrode of the driving transistor Td, i.e., Vg=Vd. At this time, Vgd=Vg−Vd=0>Vth, and Vth is negative. Hence, the driving transistor Td is in a saturation state.

In this case, the storage capacitor Cst is charged by the first voltage end VDD through the fourth transistor T4, the driving transistor Td and the second transistor T2, and the gate electrode (i.e., node N2) of the driving transistor Td is charged by the storage capacitor Cst, until the voltage applied to the node N2 is equal to VDD+Vth. In the case that V_{N2}=VDD+Vth, Vgs=Vg−Vs=VDD+Vth−VDD=Vth. At this time, the driving transistor Td is the cut-off, critical state. For the enhanced P-type transistor, the cut-off condition is Vgs>Vth, where Vth is negative. In this way, it is able to apply the threshold voltage Vth to the gate electrode of the driving transistor Td, thereby to compensate the threshold voltage Vth of the driving transistor Td. In addition, the first transistor T1, the fifth transistor T5 and the sixth transistor T6 are in the cut-off state.

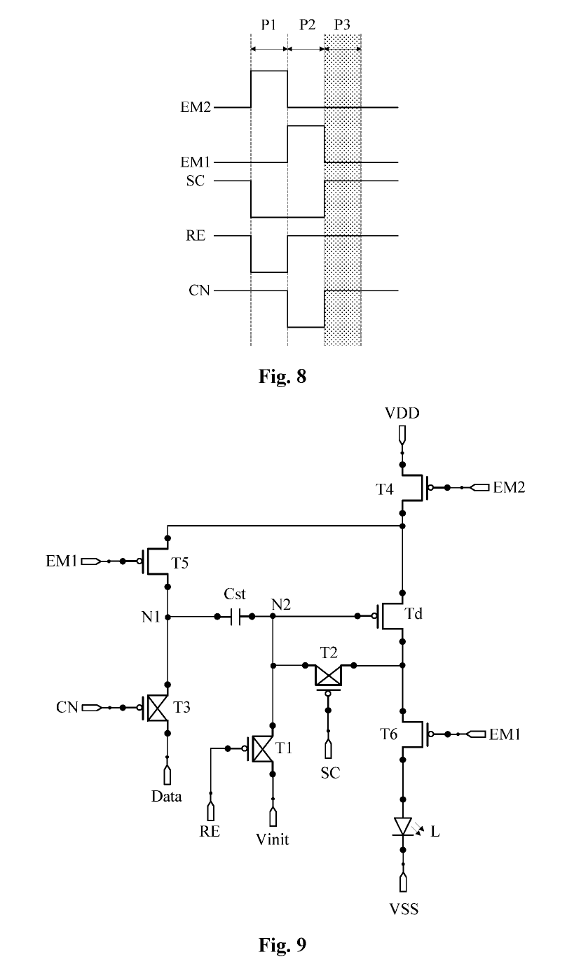

At the light-emission stage P3 within each frame, as shown in FIG. 8, EM2=0, EM1=0, SC=1, RE=1 and CN=1.

In this case, as shown in FIG. 9, a low level is applied to the second signal end EM2, so the fourth transistor T4 is turned on. A low level is applied to the first signal end ME1, so the fifth transistor T5 and the sixth transistor T6 are turned on. At this time, for the voltage applied to the node N1, V_{N1}=VDD. Because at the previous stage V_{N1}=Vdata and V_{N2}=VDD+Vth, at this stage V_{N2}=VDD−Vdata+VDD+Vth due to a bootstrapping effect of the storage capacitor Cst. At this time, Vgs=Vg−Vs=V_{N2}−Vs=(VDD−Vdata+VDD+Vth)−VDD=VDD−Vdata+Vth<Vth, and Vth is negative. Hence, the driving transistor Td is turned on. In addition, the first transistor T1, the second transistor T2 and the third transistor T3 are in the cut-off state.

Based on the above, a driving current I flowing through the light-emitting element L may be calculated through the following equation (1): I=K(Vgs−Vth)²=K(VDD−Vdata+Vth−Vth)²=K(VDD−Vdata)², where K represents a current constant associated with the driving transistor Td, and it depends on a process parameter and a geometrical size of the driving transistor Td.

In the related art, due to the threshold voltage drift, the threshold voltages Vth of the driving transistors for different pixel units are different from each other. Based on the above equation (1), in the embodiments of the present disclosure, the driving current I for driving the light-emitting element L to emit light is independent of the threshold voltage Vth of the driving transistor Td. As a result, it is able to prevent the luminous brightness of the light-emitting element L from being adversely affected by the threshold voltage Vth of the driving transistor Td, thereby to improve the brightness evenness of the light-emitting element L.

It should be appreciated that, the above description is given by taking the P-type transistors as an example. In the case that the transistors are N-type transistors, it is merely necessary to change the levels of some control signals.

The present disclosure further provides in some embodiments a display device including the above-mentioned pixel circuit. The structure and the beneficial effects of the pixel circuit have been described hereinabove, and thus will not be particularly defined herein.

It should be appreciated that, the display device may be a display device provided with a current-mode light-emitting element and including an LED or OLED display, e.g., television, mobile phone or flat-panel computer.

The display device further includes a display panel on which subpixels arranged in a matrix form. The pixel circuit is arranged within each subpixel.

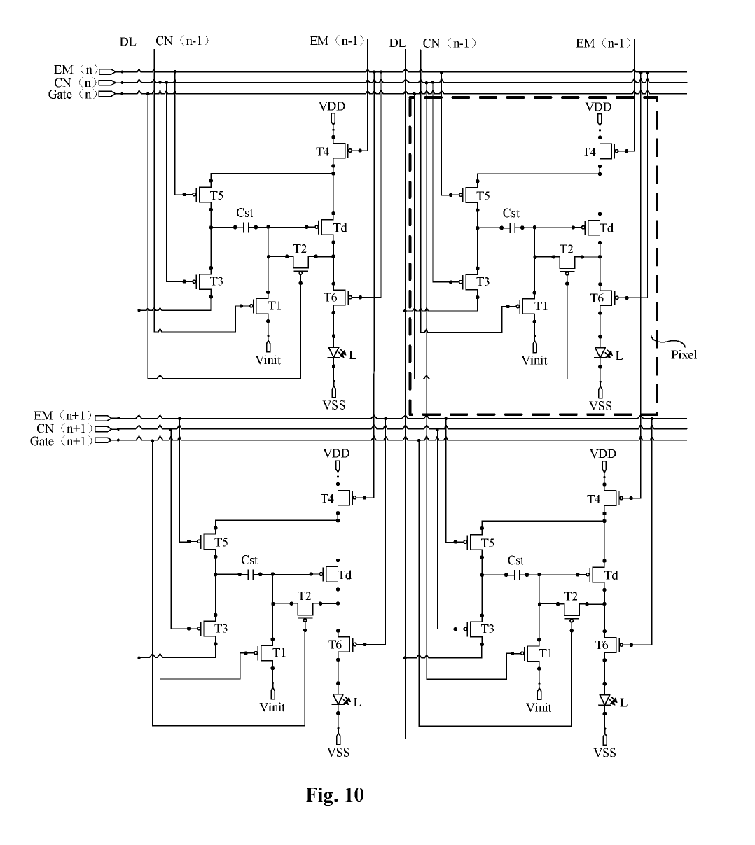

As shown in FIG. 10, the subpixels in each row are connected to a control signal line EM(n), an enabling signal line CN(n) and a scanning signal line Gate(n). The first signal end EM1 of the pixel circuit is connected to the control signal line EM(n), and the enabling signal end CN is connected to the enabling signal line CN(n), where n is a positive integer greater than 1.

Apart from the subpixels in a first row, the second signal end EM2 of the pixel circuit in each subpixel in a current row is connected to a control signal line EM(n−1) connected to each subpixel in a previous row, and the resetting signal end RE of the pixel circuit in each subpixel in the current row is connected to an enabling signal line CN(n−1) connected to each subpixel in the previous row. In this way, part of the signal lines may be shared by the subpixels in two adjacent rows to reduce the number of the signal lines and simplify the wiring structure.

The display device further includes a voltage-mode source driver connected to the data voltage end Data of each pixel circuit and configured to directly apply a data voltage to the data voltage end Data. At this time, the pixel circuit is a voltage-mode pixel circuit.

In addition, the data voltage end Data of each pixel circuit may be further connected to a current mirror. Through the current mirror, it is able to acquire the data voltage in accordance with a current signal, and apply the data voltage to the data voltage end Data. At this time, the pixel circuit is a current-mode pixel circuit.

The present disclosure further provides in some embodiments a method for driving the above-mentioned pixel circuit which includes the following steps.

At first, at the resetting stage P1 within each frame in FIG. 4, as shown in FIG. 3, the resetting module 10 outputs the voltage applied to the initial voltage end Vinit to the driving module 40 and the light-emitting module 50 under the control of the resetting signal end RE and the scanning signal end SC.

At this stage, as shown in FIG. 5, a low level is applied to each of the resetting signal end RE, the scanning signal end SC and the first signal end EM1, so the first transistor T1, the second transistor T2, the fifth transistor T5 and the sixth transistor T6 are turned on. A specific resetting procedure has been described hereinabove, and thus will not be particularly defined herein.

Next, at the write-in compensation stage P2 in FIG. 6, the data write-in module 20 writes the voltage applied to the data voltage end Data to the driving module 40 under the control of the enabling signal end CN. In addition, the compensation module 30 compensates the threshold voltage of the driving module 40 under the control of the first signal end EM1 and the second signal end EM2.

To be specific, at this stage, as shown in FIG. 6, a low level is applied to each of the enabling signal end CN, the second signal end EM2 and the scanning signal end SC. In addition, the data voltage is applied to the data voltage end Data.

In the case that the compensation module 30 includes the fourth transistor T4 and the driving module 40 includes the driving transistor Td and the storage capacitor Cst as shown in FIG. 7, at the write-in compensation stage P2, the method further includes charging, by the storage capacitor Cst, the gate electrode of the driving transistor Td. In addition, the fourth transistor T4 is turned on under the control of the second signal end EM2, so the voltage applied to the first voltage end VDD is applied to the first electrode of the driving transistor Td via the fourth transistor T4. The threshold voltage Vth of the driving transistor Td and the voltage applied to the first voltage end VDD are written into the gate electrode of the driving transistor Td. At this time, for the voltage Vg applied to the gate electrode of the driving transistor Td, Vg=VDD+Vth, so it is able to compensate the threshold voltage Vth. A specific compensation procedure has been described hereinabove, and thus will not be particularly defined herein.

Next, at the light-emission stage P3 in FIG. 8, the compensation module 30 outputs the voltage applied to the first voltage end VDD to the driving module 40 under the control of the first signal end EM1 and the second signal end EM2. In addition, the light-emitting module 50 emits light in accordance with the driving current from the driving module 40 under the control of the first signal end EM1.

To be specific, as shown in FIG. 8, at the light-emission stage P3, a low level is applied to each of the first signal end EM1 and the second signal end EM2. At this time, as shown in FIG. 9, the fourth transistor T4, the fifth transistor T5 and the sixth transistor T6 are turned on. A specific light-emission procedure has been described hereinabove, and thus will not be particularly defined herein.

It should be appreciated that, all of, or parts of, the steps may be implemented through hardware associated with programs or instructions. The programs may be stored in a computer-readable storage medium, and executed so as to perform the above-mentioned steps. The storage medium includes any media capable of storing therein program codes, such as Read Only Memory (ROM), Random Access Memory (RAM), magnetic disc or optical disc.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A pixel circuit, comprising a resetting module, a data write-in module, a compensation module, a driving module, and a light-emitting module,
wherein the resetting module is connected to a resetting signal end, a scanning signal end, an initial voltage end, the driving module and the light-emitting module, and configured to output a voltage from the initial voltage end to the driving module and the light-emitting module under the control of the resetting signal end and the scanning signal end;
the data write-in module is connected to a data voltage end, an enabling signal end and the driving module, and configured to write a voltage from the data voltage end into the driving module under the control of the enabling signal end;
the compensation module is connected to a first signal end, a second signal end, a first voltage end and the driving module, and configured to compensate a threshold voltage of the driving module under the control of the first signal end and the second signal end, and output a voltage from the first voltage end to the driving module;
the light-emitting module is connected to the first signal end, a second voltage end and the driving module, and configured to emit light in accordance with a driving current from the driving module under the control of the first signal end; and
the first voltage end is configured to output a constant high level, and the second voltage end is configured to output a constant low level.

2. The pixel circuit according to claim 1, wherein the resetting module comprises:
a first transistor, a gate electrode of which is connected to the resetting signal end, a first electrode of which is connected to the driving module, and a second electrode of which is connected to the initial voltage end; and
a second transistor, a gate electrode of which is connected to the scanning signal end, a first electrode of which is connected to the driving module and the light-emitting module, and a second electrode of which is connected to the first electrode of the first transistor.

3. The pixel circuit according to claim 1, wherein the data write-in module comprises a third transistor, a gate electrode of which is connected to the enabling signal end, a first electrode of which is connected to the data voltage end, and a second electrode of which is connected to the driving module.

4. The pixel circuit according to claim 1, wherein the compensation module comprises:
a fourth transistor, a gate electrode of which is connected to the second signal end, a first electrode of which is connected to the first voltage end, and a second electrode of which is connected to the driving module; and
a fifth transistor, a gate electrode of which is connected to the first signal end, a first electrode of which is connected to the second electrode of the fourth transistor, and a second electrode of which is connected to the driving module.

5. The pixel circuit according to claim 1, wherein the driving module comprises a driving transistor and a storage capacitor; and
a gate electrode of the driving transistor is connected to one end of the storage capacitor, a first electrode of the driving transistor is connected to the compensation module, a second electrode of the driving transistor is connected to the light-emitting module, and another end of the storage capacitor is connected to the compensation module.

6. The pixel circuit according to claim 1, wherein the light-emitting module comprises a sixth transistor and a light-emitting element; and
a gate electrode of the sixth transistor is connected to the first signal end, a first electrode of the sixth transistor is connected to the driving module, a second electrode of the sixth transistor is connected to an anode of the light-emitting element, and a cathode of the light-emitting element is connected to the second voltage end.

7. The pixel circuit according to claim 6, wherein the light-emitting element is a light-emitting diode (LED) or an organic light-emitting diode (OLED).

8. A display device, comprising the pixel circuit according to claim 1.

9. The display device according to claim 8, further comprising a display panel on which a plurality of subpixels is arranged in a matrix form, wherein
the pixel circuit is arranged in each subpixel;
the subpixels in each row are connected to a control signal line, an enabling signal line and a scanning signal line;
a first signal end of the pixel circuit is connected to the control signal line, and an enabling signal end is connected to the enabling signal line; and
apart from the subpixels in a first row, a second signal end of the pixel circuit in each subpixel in a current row is connected to the control signal line which is connected to the subpixels in a previous row, and a resetting signal end of the pixel circuit in each subpixel in the current row is connected to the enabling signal line which is connected to the subpixels in the previous row.

10. The display device according to claim 8, wherein the resetting module comprises:
a first transistor, a gate electrode of which is connected to the resetting signal end, a first electrode of which is connected to the driving module, and a second electrode of which is connected to the initial voltage end; and
a second transistor, a gate electrode of which is connected to the scanning signal end, a first electrode of which is connected to the driving module and the light-emitting module, and a second electrode of which is connected to the first electrode of the first transistor.

11. The display device according to claim 8, wherein the data write-in module comprises a third transistor, a gate electrode of which is connected to the enabling signal end, a first electrode of which is connected to the data voltage end, and a second electrode of which is connected to the driving module.

12. The display device according to claim 8, wherein the compensation module comprises:
a fourth transistor, a gate electrode of which is connected to the second signal end, a first electrode of which is connected to the first voltage end, and a second electrode of which is connected to the driving module; and
a fifth transistor, a gate electrode of which is connected to the first signal end, a first electrode of which is connected to the second electrode of the fourth transistor, and a second electrode of which is connected to the driving module.

13. The display device according to claim 8, wherein the driving module comprises a driving transistor and a storage capacitor; and
a gate electrode of the driving transistor is connected to one end of the storage capacitor, a first electrode of the driving transistor is connected to the compensation module, a second electrode of the driving transistor is connected to the light-emitting module, and another end of the storage capacitor is connected to the compensation module.

14. The display device according to claim 8, wherein the light-emitting module comprises a sixth transistor and a light-emitting element; and
a gate electrode of the sixth transistor is connected to the first signal end, a first electrode of the sixth transistor is connected to the driving module, a second electrode of the sixth transistor is connected to an anode of the light-emitting element, and a cathode of the light-emitting element is connected to the second voltage end.

15. The display device according to claim 14, wherein the light-emitting element is a light-emitting diode (LED) or an organic light-emitting diode (OLED).

16. A method for driving the pixel circuit according to claim 1, comprising steps of:
at a resetting stage within each frame, outputting, by a resetting module, a voltage from an initial voltage end to a driving module and a light-emitting module under the control of a resetting signal end and a scanning signal end;
at a write-in compensation stage within each frame, writing, by a data write-in module, a voltage from a data voltage end into the driving module under the control of an enabling signal end, and compensating, by a compensation module, a threshold voltage of the driving module under the control of a first signal end and a second signal end; and
at a light-emission stage within each frame, outputting, by the compensation module, a voltage from a first voltage end to the driving module under the control of the first signal end and the second signal end, and emitting, by the light-emitting module, light in accordance with a driving current from the driving module under the control of the first signal end.

17. The method according to claim 16, wherein the compensation module comprises a fourth transistor, and the driving module includes a driving transistor and a storage capacitor,
wherein at the write-in compensation stage, the method further comprises:
charging, by the storage capacitor, a gate electrode of the driving transistor;
enabling the fourth transistor to be turned on under the control of the second signal end to enable the voltage from the first voltage end to be applied to a first electrode of the driving transistor via the fourth transistor; and
enabling a threshold voltage of the driving transistor and the voltage from the first voltage end to be written into the gate electrode of the driving transistor.

18. The method according to claim 16, wherein at the resetting stage, each of the resetting signal end, the scanning signal end and the first signal end outputs a low level;
at the write-in compensation stage, each of the enabling signal end, the second signal end and the scanning signal end outputs a low level, and the data voltage end outputs a data voltage; and
at the light-emission stage, each of the first signal end and the second signal end outputs a low level.
